(19) United States
(12) Patent Application Publication
(10) Pub. No.: US 2009/0205038 A1
(43) Pub. Date: Aug. 13, 2009

(54) Enabling Wake on LAN Behind NATs and Firewalls

(75) Inventors: Hemant Kumar, Seattle, WA (US); Philippe Joubert, Bellevue, WA (US); Neeraj Garg, Redmond, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/028,475

(22) Filed: Feb. 8, 2008

(51) Int. Cl. G06F 17/00

(52) U.S. Cl. 726/11

(57) ABSTRACT

Exemplary methods, computer-readable media, and systems for maintaining an inbound network path to a host in a sleep or a hibernation mode behind a plurality of network address translators (NAT) or firewalls. A network interface card (NIC) of a host is configured to periodically send or receive keep-alive packets. These packets enable network mappings that would ordinarily expire while a host is in a sleep or a hibernation mode. Power is maintained on the NIC while the host is in such mode, and the NIC responds as programmed including waking a host upon a certain event, such as receiving a data packet matching a preconfigured signature. During such time, the host may be in a wake on LAN mode.

### BACKGROUND

Most Internet-connected computers today are behind a network address translator (NAT) or a firewall, or both. It is best to simultaneously use both types of devices since NATs and firewalls provide different types of protection. A particular computer is considered to be “behind” a device when inbound data traffic must pass through the device in order to reach the computer. A computer may thus appear, to other Internet-connected devices, to be behind NATs and firewalls.

Firewalls may be implemented as hardware or software, or a combination of both. Firewalls are frequently used to prevent unauthorized Internet users from accessing private networks connected to the Internet, especially intranets. All messages entering or leaving a private network pass through a firewall. A firewall typically examines each message and blocks those messages that do not meet certain specified security criteria.

NATs often separate one network from another, or an internal network from an external network such as the Internet. NATs use one set of Internet protocol (IP) addresses for internal data traffic and a second set of IP addresses for external data traffic. A NAT makes all necessary IP address translations from one network to another.

Applications or operating systems running on a computer have various techniques that enable the computer to connect to the Internet if it is behind NATs or firewalls. These techniques are often software-based and therefore require that the computer be actively running in order to maintain connectivity. Often, even though the connection is not being actively used, the computer is kept running so that it can maintain Internet connectivity just in case a connection is initiated to it from a network such as the Internet. This arrangement, however, requires that such a computer needlessly consume energy.

Most NATs and firewalls block inbound data traffic unless a host behind them initiates outbound communication. Furthermore NATs and firewalls expire network mappings unless there is active communication to or from a particular host. As a result once a host is placed in a sleep or hibernation state, the mapping expires and no further communication can be initiated inbound to that host. An inbound data packet that the host (or application running on the host) would have processed or consumed. If host were not behind a NAT, host may have otherwise woken up to process the received packet.

If the host is powered down or put into a sleep or hibernation mode, the state in most NATs or firewalls expire causing any inbound packets hitting the NAT or firewall to be discarded. Thus either the host cannot be put into a sleep mode, or communication with the host inside a NAT or firewall is going to break down.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In view of the above, this disclosure describes various exemplary systems, methods, and computer program products for allowing a computer to be placed into a sleep mode while simultaneously maintaining an open inbound connection from the Internet across any number of NATs or firewalls.

In particular, this may be done by configuring a computer's network interface card (NIC) or network card to periodically send out one or more keep-alive packets while the computer is in a sleep state. Keep-alive packets may include control information (e.g. source and destination addresses) and little or no user data. The keep-alive packets and any return packets serve to maintain an inbound path from a network such as the Internet.

In a sleep state, power is maintained to the NIC, and the NIC remains functioning. The NIC responds as programmed during the computer's sleep state. Upon receiving an appropriate inbound communication from the Internet, the NIC wakes the computer or takes other programmed action.

An open inbound connection from the Internet may also be maintained by configuring a NIC to perform certain actions when receiving inbound communications, and by configuring an external host to send keep-alive packets to the NIC through the various NATs and firewalls. In this arrangement, the NIC may take any number of actions or may take no action at all when receiving keep-alive packets. In addition, the NIC is able to wake the host or take other action if a keep-alive packet is not received within a designated time. After a pre-determined threshold amount of time, dependent upon whether an appropriate inbound communication is received via the Internet, the NIC may wake the computer or take other programmed action.

In short, the host is able to delegate certain functions to a NIC or other device or host in order to maintain an inbound connection to itself from a network through NATs and firewalls.

### BRIEF DESCRIPTION OF THE DRAWINGS

The Detailed Description is set forth and the teachings are described with reference to the accompanying figures. In the figures, the left-most digit(s) of a reference number identifies the figure in which the reference number first appears. The use of the same reference numbers in different figures indicates similar or identical items.

FIG. 1 is a block diagram of a host behind a plurality of NATs or firewalls according to at least one embodiment of enabling wake on LAN behind a plurality of NATs and firewalls.

FIG. 2 is a flowchart of an overall exemplary process for configuring a NIC according to at least one embodiment of enabling wake on LAN behind a plurality of NATs and firewalls.

FIG. 3 is a flowchart of an exemplary process whereby a NIC sends keep-alive packets to an outside host according to at least one embodiment of enabling wake on LAN behind a plurality of NATs and firewalls.

FIG. 4 is a flowchart of an exemplary process whereby an outside host sends keep-alive packets to a NIC according to at least one embodiment of enabling wake on LAN behind a plurality of NATs and firewalls.

FIG. 5 is a block diagram showing an exemplary operating environment of enabling wake on LAN behind a plurality of NATs and firewalls.

### DETAILED DESCRIPTION

This disclosure is directed to maintaining an inbound communication path to a host behind a plurality of network devices such as network address translators (NATs), firewalls, or similar devices. These network devices are referred to herein as NAT/F devices. As described herein, NAT/F may refer to a NAT or firewall, either singularly or in combinations of various quantities.

Traditionally, when a computer or host is put into a sleep or hibernation mode, there is no mechanism for inbound data packets to reach a host through NATs or firewalls. NATs and firewalls expire any address assignment which does not have active traffic during a certain predetermined period of time. Described herein are embodiments by which an inbound communication path remains open while a host is in a sleep or hibernation mode. One advantage of such arrangement is to allow a host to expend less energy while not in active use.

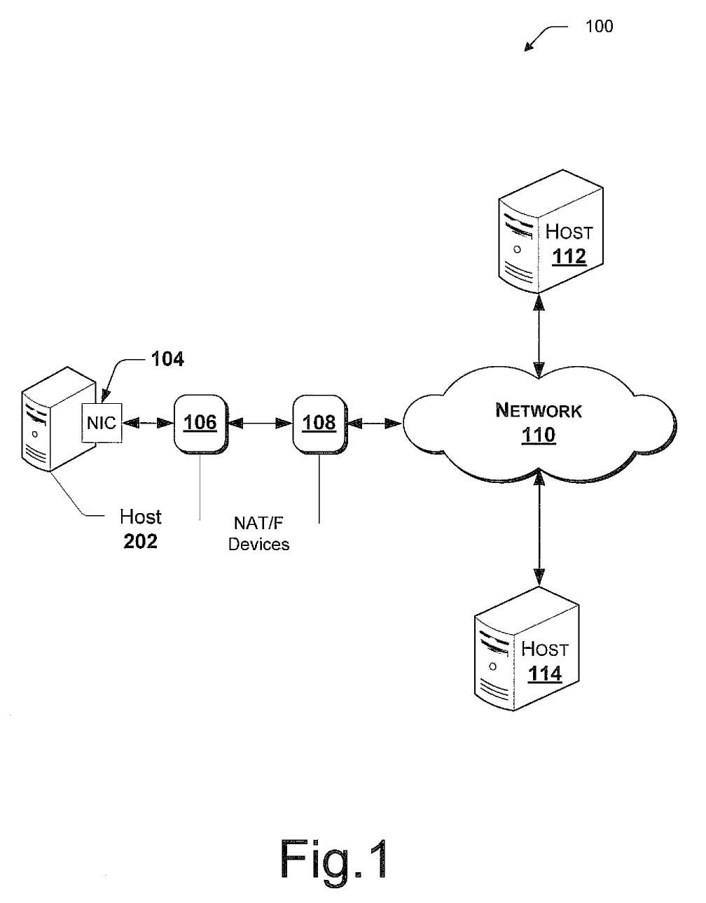

FIG. 1 illustrates a block diagram of a host behind a plurality of NAT/F devices. With reference to FIG. 1, a first host 102 is electronically in communication with a network interface card 104 or NIC. In one embodiment, a first host 102 is a computer, or other processing device, which is capable of communicating across a network and which sends or receives data across a NAT or firewall.

In a typical computer host, a NIC is physically inserted into the host's motherboard and has one or more physical ports or antennae exposed to the outside of the host device. The NIC 104 is in communication with a first NAT/F device 106 which is, in turn, in communication with a second NAT/F device 108. The connection continues from the second NAT/F device to the remainder of a network 110 such as the Internet. Those in the art understand that the network 110 may be any subset of a network, a LAN, a WAN or other type of arrangement.

In order for data to travel from a second host 112 to the first host 102, the data must travel across the network 110, through the second NAT/F device 108, through the first NAT/F device 106, and reach the NIC 104. The first host 102 can be considered behind the plurality of NAT/F devices 106, 108 from the point of view of a second host 112 or a third host 114. A second host 112 or third host 114 may be any device that communicates with the first host 102 across the network 110 and NAT/F devices 106, 108.

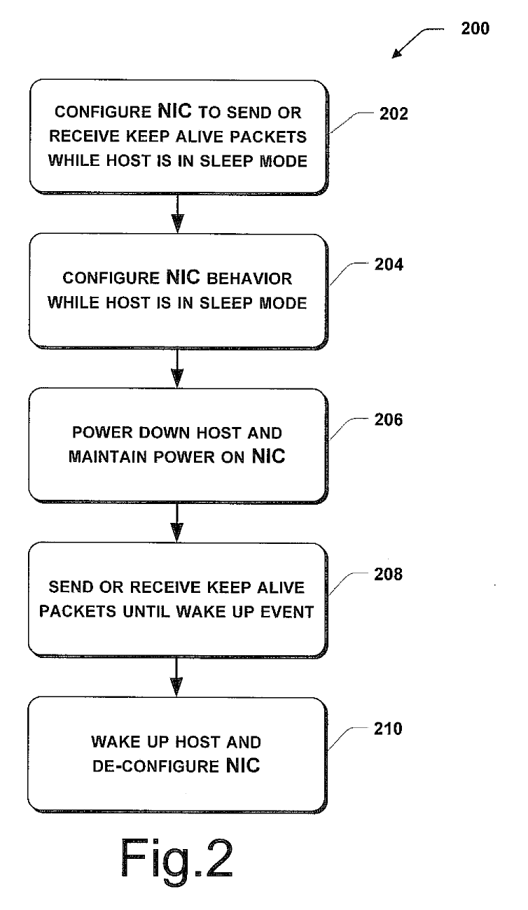

FIG. 2 is a flowchart illustrating an exemplary process for keeping an inbound path active across a plurality of NAT/F devices which may be in one of a plurality of configurations. With reference to FIG. 2, first, a NIC is configured to send or receive keep-alive packets while a host is in a sleep or hibernation mode 202.

A packet is normally a formatted block of data carried by a packet mode computer network. A packet usually consists of control information and user data or a payload. Control information is the information that the network needs to deliver the user data. For example, control information comprises source and destination addresses, error detection codes like checksums, and sequencing information. Typically, control information is found in packet headers and trailers, with user data in between.

A keep-alive packet is one or more packets sent to another device on the other side of a plurality of NAT/F devices. Keep-alive packets may be sent even when there is no user data to be sent, or when the pathway is idle or actively transferring packets. Ordinarily, networks do not include a keep-alive mechanism for various reasons such as that it consumes unnecessary bandwidth.

Next, with reference to FIG. 2, the behavior of the NIC, while the host is in the sleep or hibernation mode 204, is configured. Such configuring may take the form of programming, logic, or instructions that are transferred to the NIC. The host is then powered down into a sleep or hibernation mode while power is maintained to the NIC 206 so that the NIC may behave as configured or programmed.

The host may be maintained in its sleep or hibernation state or mode indefinitely until a pre-arranged signal, or wake-up packet or packets, is sent to the NIC, or until a user or other event wakes the host. The pre-arranged signal may be one or more wake-up packets or a specific packet, known to those in the art as a magic packet. One such event may be the lack of receiving one or more keep-alive packets within a certain time.

During this hibernation time, the NIC sends or receives keep-alive packets until the wake up event 208. At this time, the host is powered up or woken up from its sleep or hibernation mode, and the NIC is de-configured 210 or re-programmed to behave as it normally would when the host is powered up.

Two alternative methods are now presented to implement the method shown in FIG. 2.

### Sending Keep-Alive Packets

With reference to FIG. 1, a NIC 104 is programmed to send keep-alive packets (not shown) to a designated second host 112 in order to keep an inbound network path active to the first host 102 while the first host 102 is in a sleep or hibernation mode. The content of the keep-alive packets and frequency of sending the keep-alive packets are programmable. Any such modification is limited only by the capacity and functionality of the first host 102 and corresponding NIC 104. The destination host may be the same during the entire time of hibernation, may be changed on a periodic or random time or other basis, or may change due to the receipt of a particular signal or inbound data packet or set of packets. The programmed behavior of the NIC 104 and first host 102 is only limited by the capacity and functionality of the first host 102 and NIC 104 while the first host 102 is in a sleep or hibernation mode.

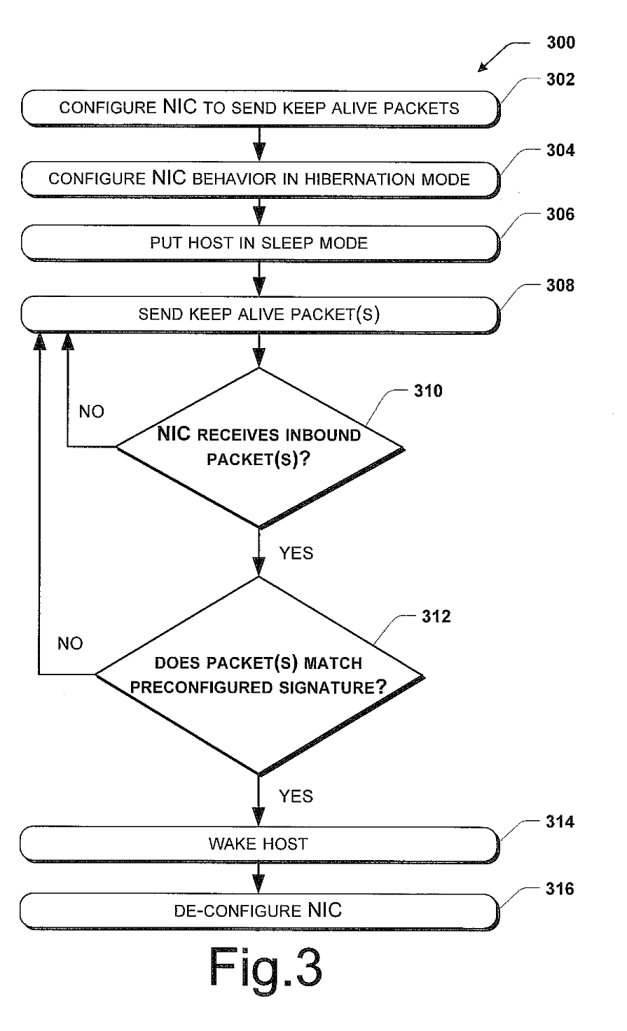

FIG. 3 illustrates one embodiment of a NIC sending keep-alive packets while its host is sleeping or hibernating. With reference to FIG. 3, the process starts by configuring a NIC to send keep-alive packets 302 to a destination host or device. Next, a user configures the NIC's behavior while its host is in its sleep or hibernation mode 304. Part of this configuring comprises providing the NIC with a predetermined packet signature. The host is then put into its sleep or hibernation mode 306. The NIC then sends keep-alive packets 308 until the host is eventually awakened from its sleep or hibernation mode.

In one particular embodiment, a NIC receives one or more response packets in response to one or more keep-alive packets. One or more of the response packets match a predetermined signature. Such response is the signal for the host to awake from its sleep or hibernation state.

The inbound network path is maintained to the host and corresponding NIC across a plurality of NAT/F devices by sending outbound keep-alive packets and optionally receiving a response. The NIC is thus capable of receiving inbound data packets.

In one scenario, if the NIC does not receive one or more inbound data packets 310 during a particular time interval, it continues to send one or more keep-alive packets 308 on a periodic basis. Alternatively, if the NIC does not receive one or more inbound data packets 310 during a particular time interval, the NIC wakes the host.

In a variation of this scenario, if the inbound packet or packets match the predetermined signature, then the NIC wakes the host 314, and the host de-configures the NIC 316 so that it no longer sends keep-alive packets to a second or other host. The NIC is returned to normal operation.

In another scenario, if the NIC receives one or more inbound data packets in an allotted time 310, the NIC compares the packet or packets to the predetermined packet signature 312. If the inbound packet or packets do not match the preconfigured signature, the NIC continues to send keep-alive packets 308.

In yet another scenario, if the NIC receives one or more inbound data packets in an allotted time 310, the NIC compares the packet or packets to the predetermined packet signature 312. If the inbound packet or packets match a predetermined packet signature 312, the NIC does nothing. Alternatively, if the inbound packet or packets do not match a predetermined packet signature 312, the NIC wakes the host. If one or more inbound packets are not received within an allotted time 310, the NIC wakes the host.

In other embodiments, the NIC or host may take other or additional actions as configured or programmed when the NIC receives inbound packets matching the predetermined packet signature. The NIC may be programmed to take any action of which it is capable upon receiving an inbound data packet whose content matches a preconfigured signature. For example, the NIC may be programmed to send a keep-alive packet on a certain frequency to a third host, instead of a second host, upon receiving such an inbound data packet.

### Receiving Keep-Alive Packets

With reference to FIG. 1, a NIC 104 is programmed to receive keep-alive packets (not shown) from a second host 112, or any other host in order to keep an inbound network path active to the first host 102 while the first host 102 is in a sleep or hibernation mode.

In one embodiment, the second host 112 is also programmed to send keep-alive packets to the first host 102 in a particular manner. For example, the content of, and frequency of sending, the keep-alive packets emanating from the second host are programmed. Any such programming is limited only by the capacity and functionality of the second host 112 or other host that is sending the keep-alive packets to the first host 102.

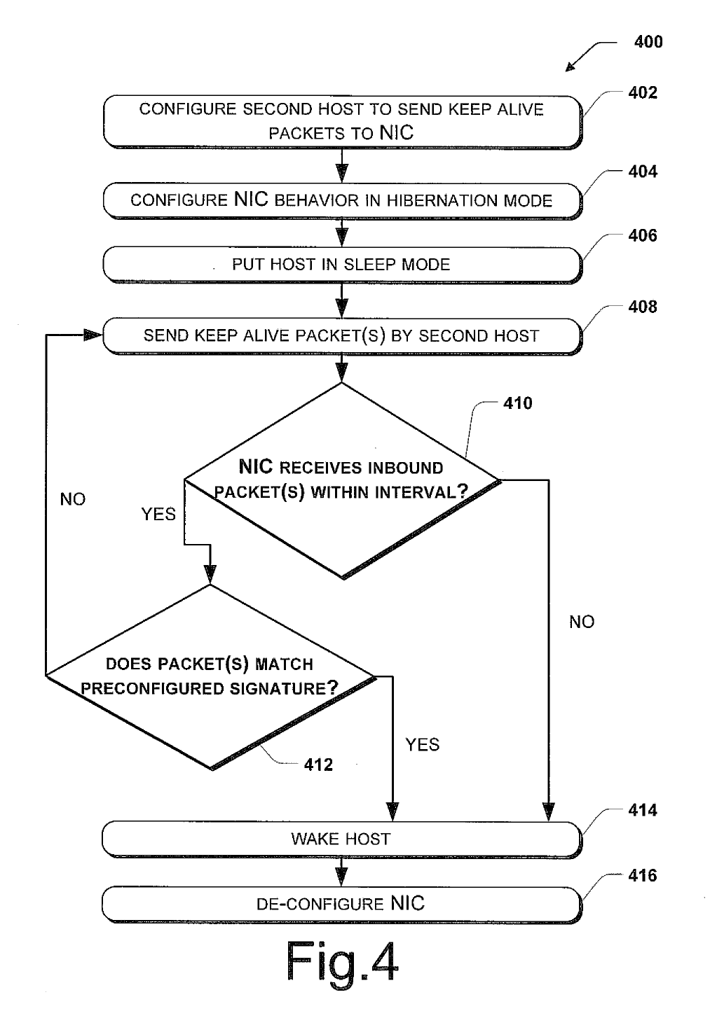

FIG. 4 illustrates this process of configuring a second or other host to maintain the inbound network pathway to a hibernating or sleeping first host. With reference to FIG. 4, the first step is to configure a second host to send keep-alive packets at a particular programmed frequency or pattern to the NIC of a first host 402. The next step is to configure the behavior of the NIC in responding to inbound packets while its host is in its sleep or hibernation mode 404.

The first host is then placed in its sleep or hibernation mode 406. The second or other host sends keep-alive packets to the first host 408 in order to maintain an inbound network path to the first host. In one embodiment, the NIC of the first host determines if it receives one or more keep-alive packets within a certain time interval 410. If the NIC does not receive a keep-alive packet, the first host is awakened from its sleep or hibernation mode 414.

If the NIC does receive a keep-alive packet, the NIC determines if the packet or packets match a preconfigured signature 412. If the match is positive, the NIC does nothing or takes another pre-programmed action. If there is no match, the first host is awakened from its sleep or hibernation mode 414. If the first host is awakened, the NIC is do-configured 416 so that it is no longer programmed to expect inbound keep-alive packets from a second or other host.

### Exemplary Operating Environment

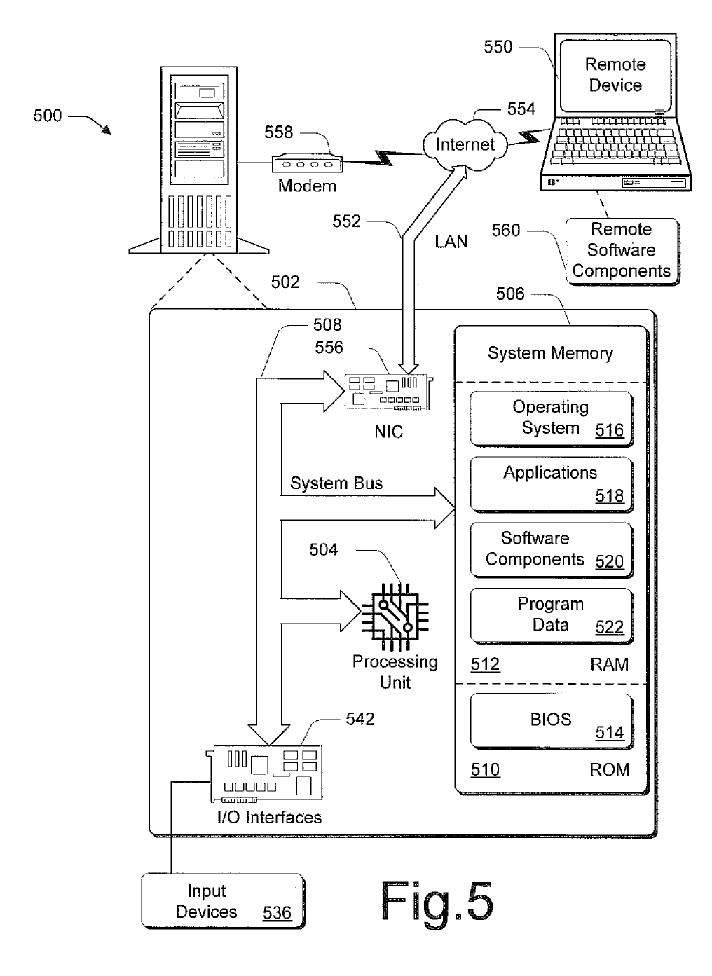

The various components and functionality described herein are implemented with a number of individual devices, hosts or computers. FIG. 5 shows components of a typical example of a computer environment 500, including a computer 502. The computer 502 may be the same as or different from the other computers or hosts 112, 114 of FIG. 1. The components shown in FIG. 5 are only examples, and are not intended to suggest any limitation.

Generally, various different general purpose or special purpose computing system configurations can be used. Examples of well known computing systems, environments, or configurations that may be suitable for use of keeping an inbound path to a host include, but are not limited to, personal computers, server computers, hand-held or laptop devices, multiprocessor systems, microprocessor-based systems, set top boxes, programmable consumer electronics, network PCs, network-ready devices, minicomputers, mainframe computers, distributed computing environments that include any of the above systems or devices, and the like.

The functionality of the computers is embodied in many eases by computer-executable instructions, such as software components, that are executed by the computers. Generally, software components include routines, programs, objects, components, data structures, and so on, that perform particular tasks or implement particular abstract data types. Tasks might also be performed by remote processing devices that are linked through a communications network. In a distributed computing environment, software components may be located in both local and remote computer storage media as previously described in relation to FIG. 1.

The instructions or software components are stored at different times in the various computer-readable media that are either part of the computer or that can be read by the computer. Programs are typically distributed, for example, on CD-ROMs, DVD, flash drives, or some form of communication media. From there, they are installed or loaded into the secondary memory of a computer. At execution, they are loaded at least partially into the computer's primary electronic memory.

For purposes of illustration, programs and other executable program components such as the operating system are illustrated herein as discrete blocks, although it is recognized that such programs and components reside at various times in different storage components of the computer, and are executed by the data processor(s) of the computer

With reference to FIG. 5, the components of computer 502 may include, but are not limited to, a processing unit 504, a system memory 506, and a system bus 508 that couples various system components including the system memory to the processing unit 504. The system bus 508 may be any of several types of bus structures including a memory bus or memory controller, a peripheral bus, and a local bus using any of a variety of bus architectures.

A computer 502 typically includes a variety of computer-readable media. Computer-readable media can be any available media that can be accessed by a computer 502 and includes both volatile and nonvolatile media, removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital video discs (DVD) or other optical disk storage, magnetic cassettes, magnetic tape, magnetic disk storage or other magnetic storage devices, or any other medium which can be used to store the desired information and which can be accessed by a computer 502.

The system memory 506 includes computer storage media in the form of volatile or nonvolatile memory such as read only memory (ROM) 510 and random access memory (RAM) 512. A basic input/output system 514 (BIOS), containing the basic routines that help to transfer information between elements within the computer 502, such as during start-up, is typically stored in ROM 510. The BIOS typically has an option to enable a wake on LAN option.

RAM 512 may contain data and software components that are typically accessible by a processing unit 504 when a computer is operating normally, not in a sleep or hibernation mode. By way of example, and not limitation, FIG. 5 illustrates an operating system 516, applications 518, software components 520, and program data 522. In one embodiment, a computer 502 is in a sleep or hibernation mode and the operating system 516, applications 518, and software components 520 are not loaded in memory. However, RAM 512 and any instructions, logic or data loaded therein, may be accessible by a network interface card (NIC) 556 when the computer 502 is in a sleep or hibernation mode.

The computer 502 may also include other removable/non-removable, volatile/nonvolatile computer storage media (not shown). Such computer storage media provide storage of computer-readable instructions, data structures, software components, and other data for the computer 502.

A user may enter commands and information into the computer 502 through input devices 536. Input devices are often connected to the computer 504 through an input output (I/O) interface 542 that is coupled to the system bus, but may be connected by other interface and bus structures, such as a parallel port, game port, or a universal serial bus (USB).

The computer operates in a networked environment using logical connections to one or more remote computers, such as a remote device 550. The remote device 550 may be the same as or different from the host 102 of FIG. 1. The remote device 550 may be a personal computer, a network-ready device, a server, a router, a network PC, a peer device or other common network node, and typically includes many or all of the elements described above relative to computer 502. The logical connections depicted in FIG. 5 include a local area network (LAN) 552 and a wide area network (WAN) 554. Although the WAN 554 shown in FIG. 5 is the Internet, the WAN 554 may also include other networks known to those in the art.

When used in a LAN networking environment, the computer 502 is connected to the LAN 552 through a NIC 556. When used in a networking environment, the computer 502 may include a modem 558 or other means for establishing communications. The modem 558, which may be internal or external, may be connected to the system bus 508 via the I/O interface 542, or other appropriate mechanism. In a networked environment, program modules depicted relative to the computer 502, or portions thereof, may be stored in the remote device 550. By way of example, and not limitation, FIG. 5 illustrates remote software components 560 as residing on the remote device 550. It will be appreciated that the network connections shown are exemplary and other means of establishing a communications link between the computers may be used.

The subject matter described above can be implemented in hardware, or software, or in both hardware and software. Although the subject matter has been described in language specific to structural features or methodological acts, it is to be understood that the subject matter defined in the appended claims is not necessarily limited to the specific features or acts described above. Rather, the specific features and acts are disclosed as exemplary forms of implementing the claimed subject matter. For example, the methodological acts need not be performed in the order or combinations described herein, and may be performed in any combination of one or more acts.

We claim:

1. A computer-readable storage media comprising computer-readable instructions that, when executed, cause a computing device to:
configure a network interface card to send keep-alive packets at a frequency to at least one destination device, the network interface card being in electronic communication with a host, the at least one destination device residing beyond a plurality of intervening network devices, wherein the frequency is sufficient to prevent from expiring an inbound network mapping to the host on the intervening network devices; and
configure the network interface card to send keep-alive packets until the network interface card receives a further action signal.

2. The computer-readable storage media of claim 1, wherein the further action signal comprises at least one of:
one or more inbound data packets from a device outside the intervening network devices, the content of the one or more inbound data packets being different from a predetermined packet signature; or
one or more inbound keep-alive response packets not being received in a predetermined time interval or
a signal from the host that the host has been taken out of a hibernation state.

3. The computer-readable storage media of claim 1, the computer-readable instructions further comprising instructions to cause the computing device to change the destination device upon the network interface card receiving a message from outside the plurality of intervening network devices.

4. The computer-readable storage media of claim 1, wherein the keep-alive packets are sent according to a pattern, the pattern being a variation comprising at least one of: frequency, packet content, packet control information, or destination device.

5. The computer-readable storage media of claim 1, the computer-readable instructions further comprise instructions to cause the computing device to:
establish a content of each keep-alive packet;
establish a frequency or pattern of sending keep-alive packets;
establish a duration for which to send keep-alive packets; and
establish at least one response to take upon receiving an inbound packet sent from outside the intervening network devices.

6. The method of claim 5, wherein the inbound packet comprises content matching a predetermined packet signature.

7. The computer-readable storage media of claim 5, wherein the at least one response is made upon the network interface card receiving at least one inbound packet, the content of the at least one inbound packet not matching any predetermined packet signature.

8. A method for maintaining an inbound network data path to a host behind a plurality of intervening network devices, the method comprising:
programming a behavior of a network interface card in response to receiving inbound keep-alive packets from a device outside the plurality of intervening network devices, the network interface card being in electronic communication with the host behind the plurality of intervening network devices;
configuring a device outside the plurality of intervening network devices to send keep-alive packets to the host behind the plurality of intervening network devices;
placing the host behind the plurality of intervening network devices into a hibernation state; and,
sending by the device outside the intervening network devices the keep-alive packets until the network interface card receives a further action signal, wherein a frequency of sending the keep-alive packets is sufficient to prevent from expiring an inbound network mapping to the host on the intervening network devices.

9. The method of claim 8, wherein the further action signal comprises at least one of:
the network interface card receiving one or more inbound data packets from the device outside the intervening network devices, the packet or packets matching a predetermined packet signature;
the network interface card not receiving at least one inbound keep-alive data packet from the device outside the intervening network devices within a given time period; and
a signal from the host behind the intervening network devices that it is being taken out of the hibernation state.

10. The method of claim 8, wherein the method further comprises:
programming the behavior of the network interface card in response to receiving inbound keep-alive packets from another device outside the intervening network devices, the network interface card being in electronic communication with the host behind the intervening network devices;
configuring a second device outside the intervening network devices to send keep-alive packets to the host behind the plurality of intervening network devices;
configuring the device presently sending inbound keep-alive packets to stop sending keep-alive packets to the host behind the intervening network devices; and
sending by the another device the keep-alive packets until the network interface card receives a further action signal, wherein the frequency of sending the keep-alive packets is sufficient to prevent from expiring an inbound network mapping to the host on the plurality of intervening network devices.

11. The method of claim 8, wherein the keep-alive packets are sent according to a pattern, the pattern being a variation comprising at least one of: frequency, packet content, packet control information, and destination device.

12. The method of claim 8, wherein the configuring of the device outside the intervening network devices further comprises:
establishing a content for each keep-alive packet;
establishing a frequency of sending keep-alive packets;
establishing a duration for which to send keep-alive packets; and
wherein the configuring of the network interface card further comprises establishing at least one response to take upon receiving an inbound packet sent from outside the intervening network devices.

13. The method of claim 12, wherein an inbound packet comprises content, wherein the content matches a predetermined packet signature.

14. The method of claim 12, wherein the at least one response is made when the network interface card receives an inbound packet that does not match any predetermined packet signature.

15. A system for maintaining an inbound network data path to a host behind a plurality of intervening network devices, the system comprising:
a network interface card in electronic communication with the host, wherein the network interface card is configured for:
sending keep-alive packets to at least one destination device outside the plurality of intervening network devices while the host is in a hibernation state,
sending the keep-alive packets until the network interface card receives a further action signal, wherein the frequency of sending the keep-alive packets is sufficient to prevent from expiring an inbound network mapping to the host through the plurality of intervening network devices, and
receiving packets from the at least one destination device, the packets being keep-alive packets or response packets elicited by keep-alive packets sent from the network interface card; and
a device beyond the plurality of intervening network devices, wherein the device is configured to send keep-alive packets to the network interface card, or configured to send response packets upon receiving one or more keep-alive packets from the network interface card, wherein the device sends packets until the device receives a further action signal.

16. The system of claim 15, wherein the further action signal comprises at least one of:
receiving one or more data packets, the content of the packet or packets matching a predetermined packet signature; or
a signal that the host of the network interface card has been taken out of the hibernation state.

17. The system of claim 15, wherein the destination device is changed by first and second messages, the first message received by the network interface card, and the second message received by the destination device.

18. The system of claim 15, wherein the configuring of the network interface card further comprises:
establishing a content for each keep-alive packet;
establishing a frequency of sending keep-alive packets;
establishing a duration for which to send keep-alive packets; and,
establishing at least one response to take upon receiving an inbound packet sent from outside the intervening network devices; and
wherein the configuring of the device beyond the plurality of intervening network devices further comprises:
establishing a content for each response packet;
establishing a frequency of sending response packets;
establishing a duration for which to send response packets; and
establishing at least one response to take upon receiving a further action signal.

19. The system of claim 18, wherein the inbound packet comprises content matching a predetermined packet signature.

20. The system of claim 18, wherein the at least one response is made when the network interface card receives an inbound packet, the content of the inbound packet not matching any predetermined packet signature.
